(19) United States
(12) Patent Application Publication
(10) Pub. No.: US 2007/0062222 A1
(43) Pub. Date: Mar. 22, 2007

(54) Method for charging particles in a material manufacturing process

(75) Inventors: Kauko Janka, Tampere (FI); Tomi Forsblom, Tampere (FI); Markku Rajala, Helsinki (FI)

Correspondence Address: VENABLE LLP, P.O. BOX 34385, WASHINGTON, DC, 20043-9998, US

(73) Assignee: LIEKKI OY, LOHJA AS (FI)

(21) Appl. No.: 10/554,083

(22) PCT Filed: Apr. 22, 2004
(86) PCT No.: PCT/FI04/50049

§ 371 Date: Sep. 7, 2006

(30) Foreign Application Priority Data
Apr. 22, 2003 (FI) 20030602

(51) Int. Cl. C03B 37/018; C03C 25/00

(52) U.S. Cl. 65/391; 65/413; 65/531

(57) ABSTRACT

A method for charging particles used for processing of a material. At least a gaseous reactant is supplied and oxidizing gas is supplied to the reactant. The oxidizing gas is charged electrically before it is supplied to the reactant. The reactant and the oxidizing gas form charged particles. The material to be processed is advantageously a multicomponent oxide construction, such as an optical fiber preform. The invention also related to a charging device implementing the method.

### BACKGROUND OF THE INVENTION

1. Field of the Invention

The invention relates to a method for charging particles, said particles being used for processing of an optical material, in which method at least a gaseous reactant is supplied and oxidizing gas is supplied to the reactant. The invention also relates to a particle charging device for forming particles, said particles being used for processing an optical material, which charging device comprises a channel for supplying a gaseous reactant, a channel for supplying oxidizing gas, and a charging member.

2. Description of the State of the Art

An optical fiber is typically formed by drawing the fiber from a fiber preform in a fiber drawing tower. The properties of the finished fiber for their part are determined on the basis of the properties of the fiber preform used in the process of drawing the fiber. The properties of the fiber preform, in turn, are determined on the basis of the manufacturing method and the manufacturing materials in use. The fiber preform can be formed in various ways, and in the process of growing the fiber preform in layers different materials are often used by means of which different properties are formed in different layers of the fiber preform.

For example in the MCVD (Modified Chemical Vapor Deposition) method gaseous and vaporous raw materials are brought via a rotating connection inside a clean silica tube (i.e. a basic tube) attached to the jaws of a glass lathe. For evaporation of liquid raw materials containers designed especially for this purpose are used, wherein carrier gas is brought to the lower part of said containers and from the upper part of the container a mixture of carrier gas and vapour is conveyed to the process. Typically used liquid raw materials with sufficiently high vapour pressure in room temperature include the main raw material of quartz glass, silicon tetrachloride (SiCl₄), germanium tetrachloride (GeCl₄) that increases the refractive index, as well as phosphorous oxytrichloride (POCl₃) that reduces the viscosity of glass and thus facilitates sintering. Furthermore, it is possible to use gases that reduce the refractive index, such as sulphur hexafluoride (SF₆) and other auxiliary gases, such as helium that improves the growing rate. The silica tube is heated from outside to a temperature of 1600 to 1800° C. with an oxygen/hydrogen burner attached to a back-and-forth moving carriage. The vapours and gases flowing inside the tube react with oxygen, thus forming very fine-grained glass dust. When the burner is moving, the burner propagating in the direction of the gas flow sinters the porous thin glass layer growing on the walls of the tube on the down-flow side of the burner as a result of thermophoresis. When the carriage of the burner reaches the other end of the tube, it returns to the starting point with a rapid movement. The number of glass layers to be grown varies between 20 and 100, depending on the fiber type. When all the necessary glass layers have been grown, the temperature of the tube is increased above the working temperature (softening temperature), approximately to 2000-2200° C., wherein the tube “collapses” as a result of surface tension and pressure difference, thus becoming a solid glass bar.

It is know to electrically charge the particles used for forming the new layers of the fiber preform. The particles are typically charged because it is possible to utilize the electrostatical forces to enhance the collection of particles. By means of a charge of the same sign it is also possible to reduce the conglomeration of particles. The conglomeration of particles may increase the porosity of the material layer formed of particles, thus making the possible sintering process more difficult. One method based in the use of charged particles is disclosed in the publication U.S. Pat. No. 6,003,342 that introduces a manufacturing method for a fiber preform in which new layers are grown electrostatically on the surface of a basic tube functioning as a frame structure. In the method the components forming the glass particles and the layer are guided via channels to a burner, whereafter the particles are charged by means of a charging member located in the burner. By means of a nozzle the particles are guided towards a counter electrode and the surface of the basic structure. By means of said implementation the distribution of the charge in the particles is uneven, and the output of the charged particles remains rather poor.

### SUMMARY OF THE INVENTION

The main purpose of the present invention is to introduce a method to be used in the manufacture of a material, especially an optical material, by means of which method it is possible to distribute the electrical charge evenly in the entire particle flow.

To attain this purpose, the method according to the invention is primarily characterized in that the oxidizing gas is charged electrically before it is supplied to the reactant and the reactant and the oxidizing gas form charged particles immediately when oxidizing gas is supplied to the reactant. The charging device according to the invention, in turn, is primarily characterized in that the charging member is arranged to charge the oxidizing gas electrically, and after the charging member the channel of the oxidizing gas is connected to a space to which the channel supplying the reactant is connected to form electrically charged particles immediately when the oxidizing gas is supplied to the reactant.

The other, dependent claims will present some preferred embodiments of the invention.

The basic idea of the invention is to produce an electrical charge in the particles used in the manufacturing process of a material, especially multicomponent oxide material, such as a fiber preform and barium-titanate (BaTiO₃), in connection with the process of forming the particles. The particles are formed by bringing various gaseous substances together in the process. According to the invention the electrical charge is produced by forming the particle of at least one electrically charged gaseous substance, which is preferably an oxidizing gas, such as air, O₂, H₂O₂, H₂O and CO₂ that oxidizes the reactant that is in gaseous form.

It is advantageous to bring the reactant flow and the flow of oxidizing gas together by guiding the oxidizing gas by means of a flow nozzle to the reactant flow. By means of the flow nozzle the oxidizing gas and the electrical charge therein are brought to that stage of the process in particular, in which the particles are formed. Thus, the charge is distributed evenly in the produced particle flow and the charge also has as much time as possible to transfer from the gas to the particle that is being formed.

In a preferred embodiment of the invention the charging of the oxidizing gas is performed in the flow nozzle by means of corona charge. Said charging makes it possible to attain high charge density, an even charge field and minimizing of breakdown liability simultaneously. In a preferred embodiment the speed of the gas flowing through the flow nozzle and the charging member is extremely high, which, in turn, has an advantageous effect on the corona discharge. High flow rate of air at the corona point is very advantageous from the point of view of charging, because thus e.g. the created ions drift quickly away from the vicinity of the corona. This expulsion of the space charging caused by ions decreases the electric field attenuating the discharge forming around the corona electrode and thus further the required corona voltage. The diminished voltage requirement, in turn, reduces the electric power required for maintaining the discharge. By charging the gas in the flow nozzle it is also possible to reduce the transfer of the charge to the structures, when compared to a situation where the charge is produced before the nozzle.

By charging the gas participating in the particle formation in accordance with the invention it is possible to attain a very even charge distribution in the particle flow that is being formed.

Furthermore, another embodiment of the invention enables high charge densities, and thus also substantial charge output, which has a very advantageous effect in the overall process.

It has been observed that the method according to the invention functions quite well in practice in connection with the manufacture of an optical fiber preform. Furthermore, the same method can also be used in the manufacture of other products. In a preferred embodiment the material to be manufactured consists of multicomponent oxide, such a bariumtitanate. The method can also be used for compounding of different materials with other materials, for example for compounding of a titaniumoxide (TiO₂) construction.

### BRIEF DESCRIPTION OF THE DRAWINGS

In the following, the invention will be described in more detail with reference to the appended principle drawings, in which

FIG. 1 shows an embodiment of the formation of electrically charged particles in accordance with the invention,

FIG. 2 shows an embodiment of particle formation apparatus according to the invention,

FIG. 3a shows an embodiment of the particle formation apparatus according to the invention in a cross-section,

FIG. 3b shows the particle formation apparatus of FIG. 3a in a front view,

FIG. 4a shows a second embodiment of the particle formation apparatus according to the invention in a cross-section,

FIG. 4b shows the particle formation apparatus of FIG. 4a in a front view, and

FIG. 5 shows an embodiment of particle formation apparatus according to the invention in connection with a fiber structure processing apparatus.

For the sake of clarity, the figures only show the details necessary for understanding the invention. The structures and details which are not necessary for understanding the invention and which are obvious for anyone skilled in the art have been omitted from the figures in order to emphasize the characteristics of the invention.

### DETAILED DESCRIPTION OF PREFERRED EMBODIMENTS

According to the invention, the electrical charge is introduced in the particle formation with the gas reacting with the reactant at that stage of the process in which the reactant is oxidized and the particles are formed. Advantageously the electrical charge is introduced in the process with oxidizing gas that reacts with the reactant, such as oxygen, air or carbon dioxide. The charge that can be either positive or negative is produced in the gas by means of a suitable charging method and device, which is preferably a corona charger, by means of which an even and efficient charge output is attained in the gas flow.

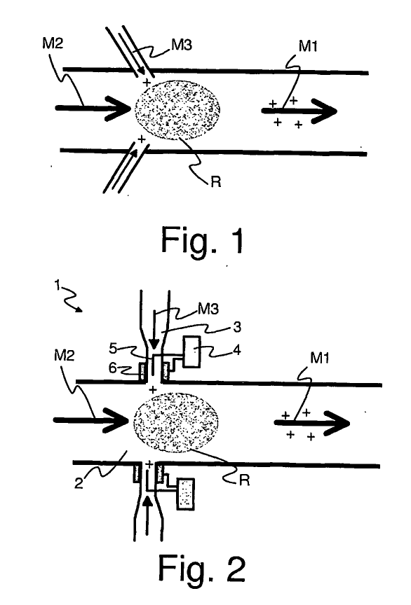

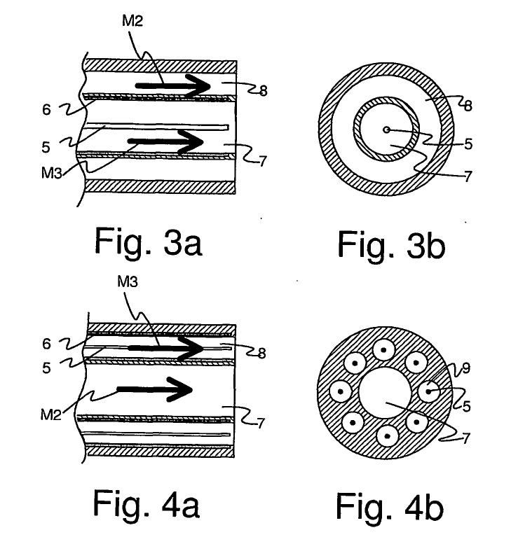

FIG. 1 shows, in principle, the formation of electrically charged particles M1 in accordance with the invention. In the example, particles M1 are formed of silicon tetrachloride M2 (SiCl₄) and oxygen M3 (O₂) in gaseous form, of which for example particles containing silicon oxide (SiO₂) are formed. Typically several components are used in the process, wherein several materials are also formed. The example is simple in order to bring forth the basic idea of the invention more clearly.

In the embodiment according to the example the oxidizing gas M3 of the process, i.e. oxygen is charged positively. The charging is conducted preferably substantially right before oxygen M3 is conveyed to the silicon tetrachloride flow M2. By charging the gas M3 right before the reaction R, the transfer of the charge elsewhere than to the particles M1 that are being formed is reduced. By conveying the charged gas M3 at as high flow rate as possible (approximately 100 m/s) to the uncharged gas flow M2, it is possible to further enhance the transfer of charge to the particles M1 formed in the reaction R, and the charge can be distributed as evenly as possible in the entire group of particles.

Typically a corona charger is used for the charging of gases, by means of which the charging is successful only in relatively low temperatures, and for example the charging of air in temperatures of over 600° C. is extremely difficult, and in practice even impossible. Thus, it is advantageous to charge the gas in room temperature. The invention is not, however, dependent on the temperature of the gas M3 to be charged. In a preferred embodiment the charge can be brought in the gas M3 in a low temperature, irrespective of the temperature prevailing in the uncharged gas flow M2 and/or the particles M1. At a later stage the temperature of the electrically charged particles M1 can increase significantly in different work stages relating to the manufacture of the product, and typically the temperature in the thermal reaction relating to the manufacture of the fiber preform is over 1000° C., in flames of different burners even over 3000° C.

FIG. 2 shows in principle a preferred embodiment of the particle form ation apparatus 1 according to the invention, that comprises a primary channel 2 and flow nozzles for the supply of gas flows. A reactant M2, such as silicon tetrachloride (SiCl₄), flows in the primary channel 2 of the particle formation apparatus 1, and the electrically charged particle flow M1 is formed thereof in the final part of the primary channel. Primarily said particle formation R takes place after the flow nozzles 3. The flow nozzle 3 via which the oxidizing gas M3 is conveyed to the primary channel 2 is arranged in the walls of the primary channel, and there may be several said flow nozzles. By means of the number, placement and directioning of the flow nozzles 3 it is possible to affect for example the way in which the oxidizing gas M3 is mixed in the reactant M2. It is advantageous to place the flow nozzles 3 around the axis of the primary channel, as shown in the example. In some embodiments it is advantageous to place several flow nozzles 3 successively in the direction of the axis of the primary channel 2.

According to the invention, the oxidizing gas M3 is electrically charged before transferring to the primary channel 2. The charging of the gas M3 can be conducted in various ways and by means of a different kind of charger, still maintaining the basic idea of the invention. Preferably, the charging of the gas M3 is based on a corona charge, as shown in FIG. 2. The figure shows a preferred embodiment of a charging member 4 that comprises a corona point 5 placed in the inner part of a flow nozzle 3 in the flow space of gas, and as a counter electrode of said corona point, an electrode structure 6 complying with the shape of the walls of the flow nozzle is arranged said electrode structure forming preferably a part of the flow nozzle, and its surface forming the inner wall of the flow nozzle. When the gas flow M3 moves via said charging member 4, it is electrically charged. The corona charging makes it possible to attain high charge densities, an even charge field and minimizing of breakdown liability simultaneously. Furthermore, the corona charger 4 also makes it possible to change the charge potential easily between a positive and negative charge. Thus, it is possible to produce both positively and negatively charged particles M1 by means of one particle formation apparatus 1.

In the flow nozzle 3 it is advantageous to use a very high flow rate of the gas M3, advantageously 80 to 300 m/s, which has an advantageous effect on the corona charge and charging of the gas. High flow rate of gas M3 at the corona point 5 is very advantageous from the point of view of charging, because thus e.g. the created ions drift quickly away from the vicinity of the corona. This expulsion of the space charging caused by ions decreases the electric field attenuating the discharge and forming around the corona electrode 5 and thereby also the required corona voltage. The high flow rate of gas M3 at the corona point 5 of the charger 4 makes it possible to reduce for example the voltage necessary in the charger, when compared to lower flow rate. For example by feeding gas M3 containing oxygen for example at a flow rate of 100 m/s it is possible to use approximately 3 kV as the charging voltage of the corona point 5. By means of a suitable design of the flow nozzle 3 and by using a sufficiently high pressure in the gas M3 to be supplied it is possible to increase the speed of the gas even above the velocity of propagation, wherein it is possible to reduce the necessary corona charge even further.

The example shown in FIG. 2 illustrates an embodiment of the flow nozzle 3 for increasing the speed of the gas M3 flowing past the corona point 5. In said embodiment the walls of the flow nozzle 3 are designed in such a manner that the flow channel of gas M3 tapers substantially towards the corona point 5, wherein the flow rate of gas increases in said point when compared to the earlier speed of the gas. The degree of tapering in the channel also depends on the pressure of the gas M3 in use, as well as on the flow rate of the gas coming to the flow nozzle 3.

According to the basic idea of the invention, charged oxidizing gas M3 is conveyed to the reactant flow M2 from the flow nozzle 3. Thus, it is possible to charge the gas M3 also before the flow nozzle 3, but it is advantageous to charge the gas in the flow nozzle, because in that case the shifting of the charge to the structures can be reduced, when compared to a situation in which the charge is produced before the flow nozzle.

The figure pairs 3a and 3b and 4a and 4b show some embodiments of the charging device 1, in which a first and a second substance is supplied from the same nozzle structure, such as the reactant M2 and the oxidizing gas M3, as shown in the figure illustrating the example. An inner channel 7 is formed in the nozzle for the first substance, and an outer channel 8 circulating the inner channel is formed for the second substance. In the first channel 7, as well as the second channel 8, it is possible to application-specifically supply either reactant M2 or oxidizing gas M3, or some other substance. It is also possible to form several channels in the nozzle, in which case several substances can also be supplied from the nozzle. Said charging devices 1 are especially advantageous in different flame processes, because the nozzle functions as an electrically charging burner, when fuel is supplied therethrough.

In the figure pair 3a and 3b, a charging member is arranged in the inner channel 7 of the nozzle, from which oxidizing gas M3 is supplied. In the example the charging member comprises a corona electrode 5 and its counter electrode 6. Thus, the oxidizing gas M3 supplied via the inner channel 7 is charged electrically and the charge transfers with the material flow to the particles formed of the oxidizing gas and the reactant M2 outside the nozzle.

In the figure pair 4a and 4b, in turn, a charging member is arranged in the outer channel 8 of the nozzle, from which oxidizing gas M3 is supplied. In the example said charging member comprises several corona electrodes 5 and their counter electrodes 6. In the embodiment in question, several mouths 9 open outward from the outer channel 8, and this has an advantageous effect on the uniform charging of the material flow. Thus, the oxidizing gas M3 supplied via the outer channel 8 of the nozzle is charged electrically and the charge transfers with the material flow to the particles formed of the oxidizing gas and the reactant M2 outside the nozzle.

After the particle formation apparatus 1 the electrically charged particles M1 formed in accordance with the invention are conveyed to further processing. For example charged glass particles M1 can be conveyed to the surface of oppositely charged fiber structure P, thus growing the fiber structure. In view of the overall process it is advantageous that the formation of particles M1 according to the invention is performed in the immediate vicinity of another process, wherein the charge of the particles lasts well. Typically, the charged particles M1 are transferred from the particle formation apparatus to further processing by means of a flow containing gas and particles.

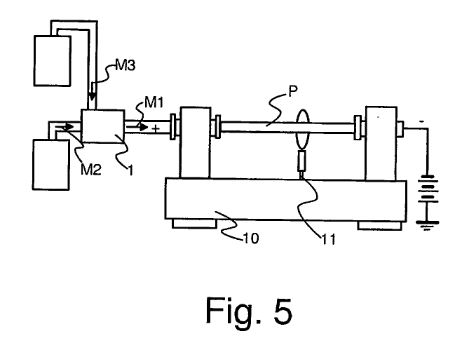

FIG. 5 shows as an example a processing apparatus 10 of a fiber preform P, such as a glass lathe, in which a basic tube P forming a part of the fiber preform is positioned in the glass lathe for the thermal process. Said thermal process constitutes a part of the manufacture of the fiber preform P. In a preferred embodiment the basic tube P is arranged to rotate with respect to its longitudinal axis. The basic tube P is arranged to be heated by a heating member 11, such as a burner or an furnace, which in the example is arranged to move in relation to the longitudinal axis of the basic tube. If necessary, the heating of the basic tube P during growing as well as the sintering and collapsing of the basic tube are conducted by means of the heating member 11. Suitable fuel gas and possible other gases used in the thermal process are brought to the heating member 11.

The electrically charged particles M1 formed by the particle formation apparatus 1 according to the invention are supplied inside the basic tube. P in a flow containing gas and particles. The basic tube P is provided with an opposite charge with respect to the particles M1, as a result of which the charged particles migrate on the inner surface of the basic tube. It is also possible to place the counter electrode outside the basic tube P, wherein the particles migrate M1 towards the counter electrode and are positioned on the inner surface of the basic tube. The particles M1 positioned on the inner surface form new layers in the fiber structure P, and several such layers can be grown on top of each other.

The electrical charging of particles M1 according to the invention is not, however, dependent on the above-presented embodiment. The formation of charged particles M1 according to the invention and the growing of layers by means of the particles can be performed separately from the presented thermal process, and for example for the collapsing the electrostatically grown structure can be arranged in a separate process. For reasons relating to the manufacture it is, however, often advantageous to implement the combination of the processes in the manner shown in the example. Furthermore, charged particles M1 can be used for other purposes as well, and in apparatuses other than the one mentioned in the example. In these apparatuses the possible charging of the target of particles M1 can be performed in various ways, for example by means of the above-described direct charging of the target, or by means of solutions based on electrode structures.

Naturally, it will be obvious that the invention is not limited solely to the embodiment presented in the above examples, but, for example, the reactant M2 may be different from silicon tetrachloride (SiCl₄), for example aluminiumchloride (AlCl₃).

Furthermore, the invention is not restricted to the manufacture of an optical fiber preform as presented in the examples above, which is one preferred embodiment of the invention, but it is impossible to apply the method and/or device according to the invention in the manufacture of several different materials. Advantageously the material to be manufactured is multicomponent oxide, such a barium titanate. The method can also be used for compounding of different materials with other materials, for example for compounding of a titaniumoxide (TiO₂) construction.

By combining, in various ways, the modes and structures disclosed in connection with the different embodiments of the invention presented above, it is possible to produce various embodiments of the invention in accordance with the spirit of the invention. Therefore, the above-presented examples must not be interpreted as restrictive to the invention, but the embodiments of the invention can be freely varied within the scope of the inventive features presented in the claims hereinbelow.

1-11. (canceled)

12. A method for charging particles in a flame process, which particles are used for processing of an optical material, the method comprising:
supplying a gaseous reactant;
electrically charging an oxidizing gas; and
supplying the oxidizing gas in the reactant,
wherein the reactant and the oxidizing gas form charged particles immediately when oxidizing gas is supplied to the reactant.

13. The method according to claim 12, wherein the oxidizing gas is charged in a nozzle by means of which gas is conveyed to the space comprising oxidizing material.

14. The method according to claim 12, wherein the oxidizing gas, whose flow rate is 80 to 300 m/s, is charged by means of a corona charger.

15. The method according to claim 13, wherein the oxidizing gas, whose flow rate is 80 to 300 m/s, is charged by means of a corona charger.

16. The method according to claim 12, wherein the material to be processed is a fiber preform or another multicomponent oxide construction or a titanium oxide construction.

17. The method according to claim 13, wherein the material to be processed is a fiber preform or another multicomponent oxide construction or a titanium oxide construction.

18. The method according to claim 14, wherein the material to be processed is a fiber preform or another multicomponent oxide construction or a titanium oxide construction.

19. The method according to claim 15, wherein the material to be processed is a fiber preform or another multicomponent oxide construction or a titanium oxide construction.

20. A particle charging device for forming particles in a flame process, which particles are used at least for processing of an optical material, the charging device comprising:
a channel for supplying a gaseous reactant;
a channel for supplying oxidizing gas; and
a charging member operative to charge the oxidizing gas electrically,
wherein after the charging member the channel of the oxidizing gas is connected to a space, to which the channel supplying the reactant is connected, to form electrically charged particles immediately when the oxidizing gas is supplied to the reactant.

21. The charging device according to claim 20, wherein the charging member is a corona charger.

22. The charging device according to claim 21, wherein the charging member is a corona charger.

23. The charging device according to claim 20, wherein the channel of oxidizing gas is connected to the channel of the reactant at least by means of one nozzle to convey the oxidizing gas to the channel of the reactant.

24. The charging device according to claim 21, wherein the channel of oxidizing gas is connected to the channel of the reactant at least by means of one nozzle to convey the oxidizing gas to the channel of the reactant.

25. The charging device according to claim 22, wherein the channel of oxidizing gas is connected to the channel of the reactant at least by means of one nozzle to convey the oxidizing gas to the channel of the reactant.

26. The charging device according to claim 23, wherein the nozzle is designed to taper in such a manner that the speed of the gas flowing therethrough is increased.

27. The charging device according to claim 24, wherein the nozzle is designed to taper in such a manner that the speed of the gas flowing therethrough is increased.

28. The charging device according to claim 25, wherein the nozzle is designed to taper in such a manner that the speed of the gas flowing therethrough is increased.

29. The charging device according to claim 23, wherein the nozzle comprises a charging member.

30. The charging device according to claim 20, further comprising:
a first gas supply channel in which a charging member is arranged to charge the gas; and
a second gas supply channel that surrounds the first gas supply channel.

31. The charging device according to claim 20, further comprising:
a first gas supply channel;
a second gas supply channel surrounding the first gas supply channel; and
a charging member arranged in the second gas supply channel to charge the gas.
